(19) United States
(12) Patent Application Publication
(10) Pub. No.: US 2009/0034860 A1
(43) Pub. Date: Feb. 5, 2009

(54) IMAGE-DRAWING METHOD, IMAGE-DRAWING DEVICE, IMAGE-DRAWING SYSTEM, AND CORRECTION METHOD

(75) Inventor: Takuya Hirashima, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM CORPORATION, Tokyo (JP)

(21) Appl. No.: 11/815,272

(22) PCT Filed: Feb. 21, 2006
(86) PCT No.: PCT/JP2006/303534

§ 371 Date: Aug. 1, 2007

(30) Foreign Application Priority Data
Feb. 21, 2005 (JP) 2005-044452

(51) Int. Cl. G06K 9/40

(52) U.S. Cl. 382/254

(57) ABSTRACT

A correction method for an image-drawing device which carries out alignment on an object on the basis of reference position data acquired by reading a position reference mark or pattern provided at the object, and which carries out image-drawing on the object in accordance with image data while moving the object in a scanning direction is provided. The correction method carries out correction of an image-drawing position with respect to deformation of the object before correction of an image-drawing position with respect to a position of the object. In this way, a processing ability of the image-drawing device can be improved.

### BACKGROUND OF THE INVENTION

1. Field of the Invention

The present invention relates to an image-drawing method, an image-drawing device, and a correction method, and in particular, relates to an image-drawing method, an image-drawing device, an image-drawing system, and a correction method thereof which carry out exposure of a photosensitive material used as a multilayer substrate.

2. Description of the Related Art

Conventionally, in an exposure device which carries out scan-exposure of a work such as a substrate on which a photosensitive material is coated or laminated or the like, in order to accurately adjust the exposure position in the X-Y direction with respect to the work, alignment marks, which are provided at the work and are references for the exposure position, are photographed by alignment cameras such as CCD cameras or the like, before exposure is carried out. Alignment, which adjusts the exposure position to the correct position, is carried out on the basis of the mark measurement positions (reference position data) obtained by the photographing. Plural types of works, which have different sizes and different positions of the alignment marks, are the objects of exposure of the exposure device. Therefore, the alignment cameras are structured so as to be able to photograph even in cases in which the positions of the alignment marks are changed in the direction orthogonal to the scanning direction. For example, the alignment cameras are guided by guide rails or the like which are provided so as to extend along the direction (X direction) orthogonal to the scanning direction, and are driven by driving mechanisms such as ball screws or the like, and can be moved to and positioned at arbitrary positions over the entire range of the X direction dimension of the object of exposure. Then, the positions of the alignment cameras are detected/measured by a position detecting section such as a linear scale or the like, and the aforementioned alignment is carried out by using these positions as a reference (see, for example, Japanese Patent Application Laid-Open (JP-A) No. 8-222511).

Here, in a case in which a large number of substrates, which are objects of exposure, are processed in continuation, the deformation, which is caused by warping or expansion or contraction of the substrate which is the object of exposure, differs at each substrate. Therefore, the amount of correction of the exposure position must be computed each time in order to correct the deformation. This warping correction processing imposes a very large burden on the exposure device. Further, the correction amount is a value which differs for each substrate, and is different than the position or posture at the time when the substrate is set at the exposure device.

However, conventionally, the aforementioned two types of correction, i.e., the correction of the exposure position which corrects the deformation per substrate and the correction of the exposure position which corrects the position or posture at the time when the substrate is set at the stage of the exposure device, are carried out substantially simultaneously. Thus, the burden on the control device which computes this is large, and, as a result, the processing ability of the entire device deteriorates.

Moreover, when carrying out exposure of both sides of a substrate, the aforementioned problem of the processing ability deteriorating is particularly marked in a method which carries out deformation correction by obtaining deformation correction data of one side of the substrate at the time of exposing that side, and obtaining data of reverse side again at the time of exposing the reverse side.

### SUMMARY OF THE INVENTION

In view of the aforementioned, the present invention provides an image-drawing device and a correction method thereof which can improve the processing ability by, in the alignment function, carrying out correction with respect to deformation of an object of image-drawing before carrying out correction with respect to the position and the posture of the object of image-drawing.

A first aspect of the present invention provides a correction method of an image-drawing device which carries out alignment on an object on the basis of reference position data acquired by reading a position reference mark or pattern provided at the object, and which carries out image-drawing on the object in accordance with image data while moving the object in a scanning direction, the method including: carrying out first correction which corrects an image-drawing position with respect to deformation of the object; and carrying out second correction which corrects an image-drawing position with respect to a position of the object, wherein the first correction is carried out before the second correction.

By carrying out first correction with respect to deformation of the work (the object) separately from and in advance of second correction of the position on the stage, the processing ability of the entire device can be improved.

The present correction method may be structured such that the first correction is carried out by using a number of position reference marks or patterns, which number is greater than or equal to that used in the second correction.

The computation of the position information on the stage, which is needed immediately before exposure, can be achieved by measuring a number of position reference marks, which number is less than or equal to that used in computing the position information used in correcting the image-drawing position with respect to the deformation. In this way, the operation time can be shortened, and the processing ability can be improved.

The present correction method may be structured such that, before the image-drawing ends, the first correction with respect to deformation of an object which is to be image-drawn next is completed.

By computing the deformation correction of the next work by utilizing the exposure time, the processing ability of the entire device can be improved.

The present correction method may be structured such that a plurality of the position reference marks or patterns are read by an auxiliary reading section which is provided in advance at an exterior of the image-drawing device, and the first correction is carried out on the basis of acquired reference position data, and thereafter, the second correction is carried out on the basis of reference position data acquired by reading by a reading section which is provided at the image-drawing device.

The processing ability of the entire device can be improved by carrying out the correction with respect to the deformation of the work separately from the correction of the position on the stage, at an auxiliary reading section which is provided in advance at the exterior of the device.

The present correction method may be structured such that a see-through reading section using X-rays is used as the auxiliary reading section.

By using X-rays as the auxiliary reading section, position information which is difficult to read by visible light rays, such as an inner layer of a multilayer substrate or the like, can be read.

The present correction method may be structured such that, when the image-drawing device is carrying out image-drawing of both sides by using a through-hole as a position reference, during image-drawing of one side, the first correction with respect to deformation of another side is carried out on the basis of position data which rotates or reverses reference position data acquired from the position reference mark or pattern for the side currently in the midst of image-drawing.

The processing ability of the entire device can be improved by using deformation correction data of one side to compute deformation correction of the other side of the work.

The present correction method may be structured such that a see-through reading section using X-rays is provided at a device which carries out marking or hole-punching processing on a substrate structuring the object, and the first correction is carried out on the basis of reference position data acquired by reading position information of an inner layer structure of the substrate by the see-through reading section.

The processing ability of the entire device can be improved by carrying out the correction with respect to the deformation of the work separately from the correction of the position on the stage, at an auxiliary reading section which is provided in advance at the exterior of the device.

The present correction method may be structured such that the image-drawing is exposure processing by light beams.

A second aspect of the present invention provides an image-drawing device including: a reading section reading a position reference mark or pattern provided at an object; an aligning section carrying out alignment for the object on the basis of reference position data acquired by reading by the reading section; a moving section moving the object in a scanning direction; and an image-drawing section carrying out image-drawing on the object in accordance with image data, while moving the object in the scanning direction by the moving section, wherein the aligning section carries out first correction which corrects an image-drawing position with respect to deformation of the object, before second correction which corrects an image-drawing position with respect to a position of the object.

In the present aspect, by carrying out correction with respect to deformation of the work in advance of and separately from the correction of the position on the stage, the processing ability of the entire device can be improved.

The present image-drawing device may be structured such that the first correction is carried out by using a number of position reference marks or patterns, which number is greater than or equal to that used in the second correction.

The computation of the position information on the stage, which is needed immediately before exposure, can be achieved by measuring a number of position reference marks, which number is less than or equal to that used in computing the position information used in correcting the image-drawing position with respect to the deformation. The processing ability can thereby be improved.

The present image-drawing device may be structured such that, before the image-drawing ends, the first correction with respect to deformation of an object which is to be image-drawn next is completed.

By computing the deformation correction of the next work by utilizing the exposure time, the processing ability of the entire device can be improved.

The present image-drawing device may be structured such that a plurality of the position reference marks or patterns are read by an auxiliary reading section which is provided in advance at an exterior of the image-drawing device, and the first correction is carried out on the basis of acquired reference position data, and thereafter, the second correction is carried out on the basis of reference position data acquired by reading by the reading section which is provided at the image-drawing device.

The processing ability of the entire device can be improved by carrying out the correction with respect to the deformation of the work separately from the correction of the position on the stage, at an auxiliary reading section which is provided in advance at the exterior of the device.

The present image-drawing device may be structured such that a see-through reading section using X-rays is used as the auxiliary reading section.

By using X-rays as the auxiliary reading section, position information which is difficult to read by visible light rays, such as an inner layer of a multilayer substrate or the like, can be read.

The present image-drawing device may be structured such that, when the image-drawing device is carrying out image-drawing of both sides by using a through-hole as a position reference, during image-drawing of one side, the first correction with respect to deformation of another side is carried out on the basis of position data which rotates or reverses reference position data acquired from the position reference mark or pattern for the side currently in the midst of image-drawing.

The processing ability of the entire device can be improved by using deformation correction data of one side to compute deformation correction of the other side of the work.

The present image-drawing device may be structured such that a see-through reading section using X-rays is provided at a device which carries out marking or hole-punching processing on a substrate structuring the object, and the first correction with respect to deformation of the object is carried out on the basis of reference position data acquired by reading position information of an inner layer structure of the substrate by the see-through reading section.

The processing ability of the entire device can be improved by carrying out the correction with respect to the deformation of the work separately from the correction of the position on the stage, at an auxiliary reading section which is provided in advance at the exterior of the device.

The present image-drawing device may be structured such that the image-drawing is exposure processing by light beams.

A third aspect of the present invention provides an image-drawing method for forming an image on an object by using an image-drawing section, the method including: measuring deformation of the object; carrying out deformation correction processing for forming a deformed image on the object in accordance with the deformation; measuring a positional error of the object with respect to the image-drawing section; carrying out position correction processing for forming an image, whose position is corrected, on the object in accordance with the positional error; and image-drawing an image on the object, wherein the deformation correction processing is completed before the measuring of the positional error or the position correction processing.

Correction with respect to the deformation of the work is carried out, as the deformation correction processing, in advance of and separately from the position correction processing on the stage. The processing ability of the entire device can thereby be improved.

The present method may be structured such that, at a stage when the position correction processing with respect to a first partial region of the object is completed, image-drawing of the image with respect to the first partial region is started.

By carrying out exposure successively from a region for which correction has been completed, the correction processing and exposure processing can be carried out in parallel.

The present method may be structured such that, simultaneously with the image-drawing of the image with respect to the first partial region, the position correction processing with respect to a second partial region of the object is carried out.

In this way, the correction processing and exposure processing can be carried out in parallel.

The present method may be structured such that, simultaneously with at least one of a). the measuring of the positional error with respect to the object, b). the position correction processing, and c). the image-drawing of the image, the deformation correction processing with respect to another object is carried out.

In this way, the correction processings can be carried out in parallel.

The present method may be structured such that the measuring of the deformation is carried out by reading, in a see-through manner and by using X-rays, a position of a mark or a pattern provided at the object.

By carrying out measurement of the deformation by using X-rays, position information which is difficult to read by visible light rays, such as an inner layer of a multilayer substrate or the like, can be read.

The present method may be structured such that at least one of the measuring of the deformation and the measuring of the positional error is carried out by reading a position of a mark or a pattern provided at the object.

A fourth aspect of the present invention provides an image-drawing method for forming an image on an object by using an image-drawing section, the method including: a first correction step of measuring positions of at least two reference marks or patterns on the object, and carrying out correction processing for forming, on the object, an image corresponding to a relative positional relationship between the positions of the reference marks or patterns; a second correction step of measuring the positions of the at least two reference marks or patterns on the object, or positions of at least two other reference marks or patterns, and carrying out correction processing for forming, on the object, an image corresponding to a positional relationship between the image-drawing section and the positions of the reference marks or patterns; and a step of image-drawing an image on the object, wherein the first correction step is completed before the second correction step.

By carrying out correction with respect to the deformation of the work before the position correction processing, the processing ability of the entire device can be improved.

A fifth aspect of the present invention provides an image-drawing system for forming an image on an object by using an image-drawing section, the system including: a measuring section measuring deformation of the object; a deformation correction processing section for forming a deformed image on the object in accordance with the deformation; a positional error measuring section measuring a positional error of the object with respect to the image-drawing section; a position correction processing section for forming an image, whose position is corrected, on the object in accordance with the positional error; and an image-drawing section carrying out image-drawing of an image on the object, wherein the deformation correction processing is completed before the measuring of the positional error or the position correction processing.

By carrying out correction with respect to the deformation of the work before the position correction processing, the processing ability of the entire device can be improved.

Owing to the above-described structures, the present invention provides an image-drawing method, an image-drawing device, an image-drawing system, and a correction method thereof which can improve the processing ability by, in the alignment function, carrying out correction with respect to the deformation of an object of image-drawing before carrying out correction with respect to the position and the posture of the object of image-drawing.

### BRIEF DESCRIPTION OF THE DRAWINGS

FIG. 1 is a drawing showing an exposure system relating to a first embodiment of the present invention.

FIGS. 2A and 2B are drawings showing a method of correcting warping of a work relating to the first embodiment of the present invention.

FIG. 3 is a flowchart of the exposure system relating to the first embodiment of the present invention.

FIGS. 4A through 4C are drawings explaining operation of the exposure system relating to the first embodiment of the present invention.

FIG. 5 is a perspective view showing an exposure device relating to a second embodiment of the present invention.

FIG. 6 is a perspective view showing an alignment unit relating to the second embodiment of the present invention.

FIG. 7 is a side view showing alignment adjustment relating to the second embodiment of the present invention.

FIGS. 8A through 8C are drawings showing a method of detecting positional offset and warping of a work relating to the present invention.

FIGS. 9A through 9E are drawings showing a method of correcting warping of a work relating to the present invention.

FIGS. 10A through 10E are drawings showing a method of correcting warping of a work relating to the present invention.

FIG. 11 is a perspective view showing an exposure device relating to a third embodiment of the present invention.

FIG. 12 is a drawing showing a method of detecting positional offset and warping of an exposure device relating to a fourth embodiment of the present invention.

### DESCRIPTION OF THE PREFERRED EMBODIMENT

### Outline of Device

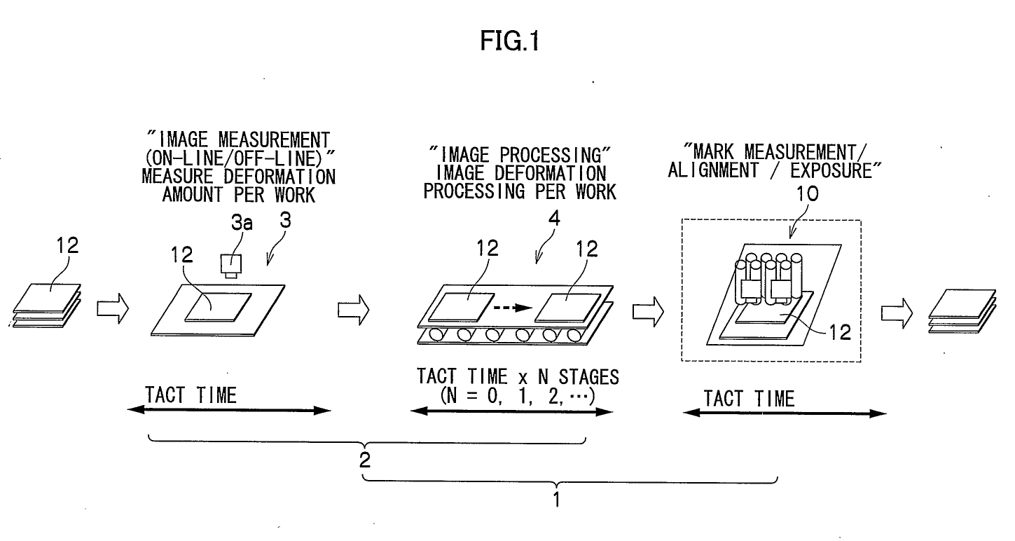

An exposure system relating to a first embodiment of the present invention is shown in FIG. 1.

As shown in FIG. 1, an exposure system 1 is structured from an exposure device 10 and an option device 2. The option device 2 is structured from an image measuring device 3 and an image processing device 4.

At the image measuring device 3, alignment marks (and/or edges of a work/substrate), the position of a pattern formed in an inner layer, or the like which are provided at a work (the object in the present invention) 12 such as a substrate or the like on which a photosensitive material is coated or laminated, are measured by a reading device 3a, and the amount of deformation of the work 12 is measured for each work 12. Note that expansion or contraction of the work 12 in one direction can be measured by two or more marks, and other types of deformation can be measured by three or more marks.

Next, at the image processing device 4, deformation processing of the exposure image is carried out on the work 12 on the basis of the deformation amount of the work 12 which was measured at the image measuring device 3. Namely, by carrying out deformation processing on the exposure image in accordance with the deformation amount of the work 12 which was measured by the image measuring device 3, an exposure image, which is deformed according to the deformation of the work 12, is determined.

Then, the work 12 is conveyed to the exposure device 10, and the exposure image, which has been subjected to the deformation processing at the image processing device 4, is formed on the exposure surface. At this time, because the exposure image has been subjected to the deformation processing in accordance with the deformation amount of the work 12 measured at the image measuring device 3, the exposure image is a deformed image. Note that the image processing device 4 may be structured by using a device (or a process) which conveys the work 12 from the measuring device 3 to the exposure device 10.

The tact time shown by the black arrow in FIG. 1 is, for the measurement at the image measuring device 3 and for the exposure at the exposure device 10, the required time as is, and, for the image processing at the image processing device 4, is the processing time of each stage in a case in which pipeline processing which will be described later is carried out. The time (Tact Time×N), which is the processing time multiplied by the number of stages (N stages), is the image processing time for one substrate.

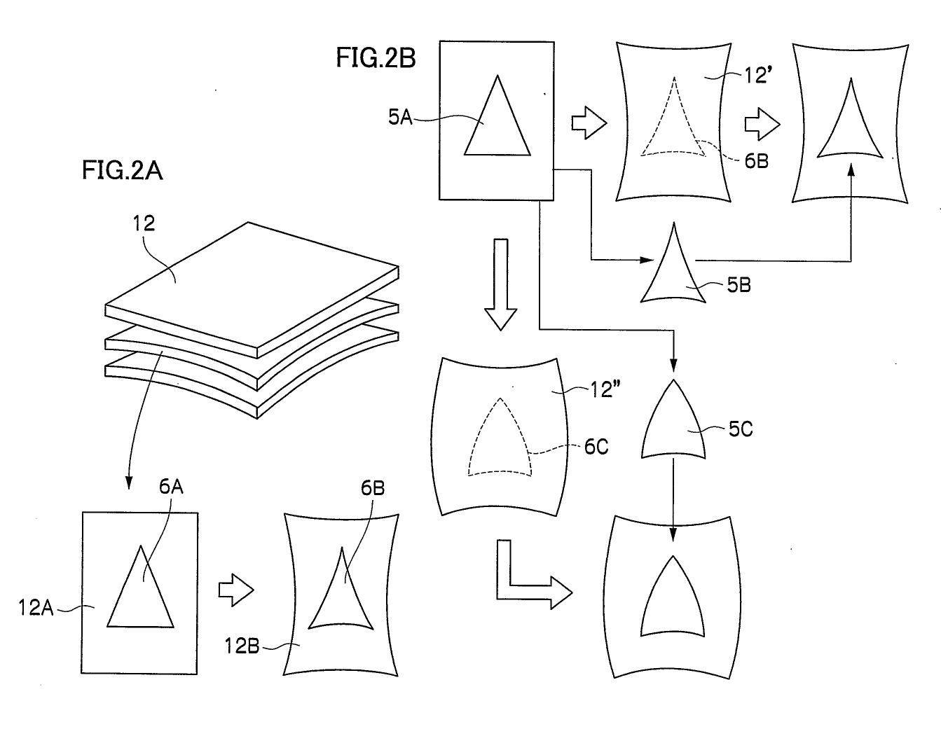

Examples of the relationship between the exposure image and the deformation of the work in the exposure system relating to the first embodiment of the present invention, are shown in FIG. 2.

As shown in FIG. 2A, in a case in which the work 12 is a multilayer substrate for example, if the work 12 is a work 12A which is not deformed, an image 6 formed thereon also is an image 6A which is not deformed, and there is therefore no problem. However, in a case in which the work 12 deforms and is a shape such as a work 12B, the image 6 formed thereon also deforms, and is a shape such as an image 6B.

If a layer is formed on the deformed work 12B, i.e., the deformed image 6B, such that an outer layer is provided on the work 12B which is the inner layer, the deformed image 6B becomes problematic. Namely, in a multilayer substrate, the image (pattern) formed on the inner layer and the image (pattern) formed on the outer layer must match (or correspond). When at the inner layer, there is the image 6B in which the formed image 6 is deformed, if a deformed image is not formed on the outer layer so as to match this deformed image 6B, the image 6B of the inner layer and the image 6 of the outer layer will not match.

Thus, in the present embodiment, as shown in FIG. 2B, the exposure image which is to be exposed onto the outer layer is deformed according to the deformation of the inner layer, such that the image formed on the inner layer and the exposure image to be exposed on the outer layer are made to match one another.

Namely, if the work 12 deforms and is a configuration such as 12′, the image formed on the inner layer also deforms as shown by 6B which is illustrated by the dotted line. By deforming an exposure image 5A to be like 5B in accordance therewith, the deformed image 6B formed on the inner layer and the exposure image 5B to be exposed on the outer layer can be made to match.

Or, in a case in which the work 12 deforms and is a configuration such as 12″, the image formed on the inner layer also is deformed as shown by 6C which is illustrated by the dotted line. By deforming the exposure image 5A to be like 5C in accordance therewith, the deformed image 6C formed on the inner layer and the exposure image 5C to be exposed on the outer layer can be made to match.

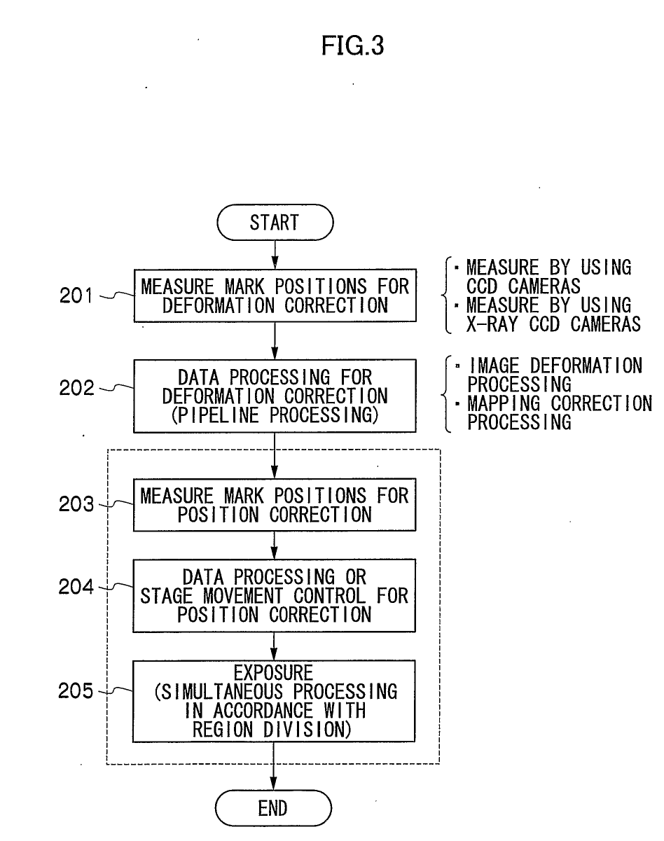

The flow of the above-described series of processing steps is shown as a flowchart in FIG. 3. FIG. 3 shows the processing flow of the exposure system relating to the first embodiment of the present invention.

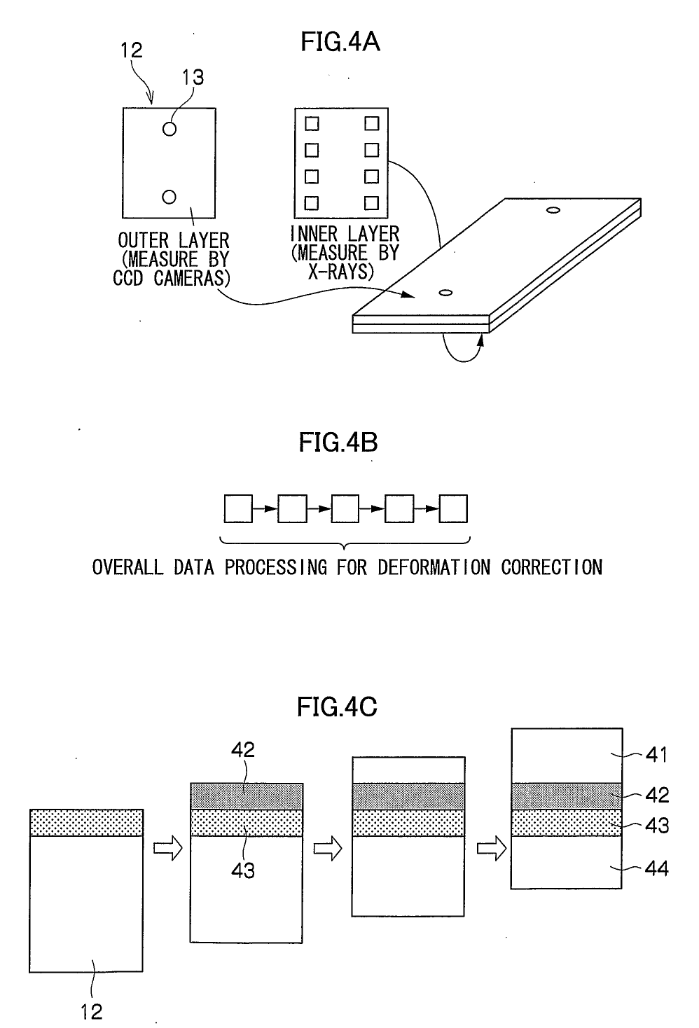

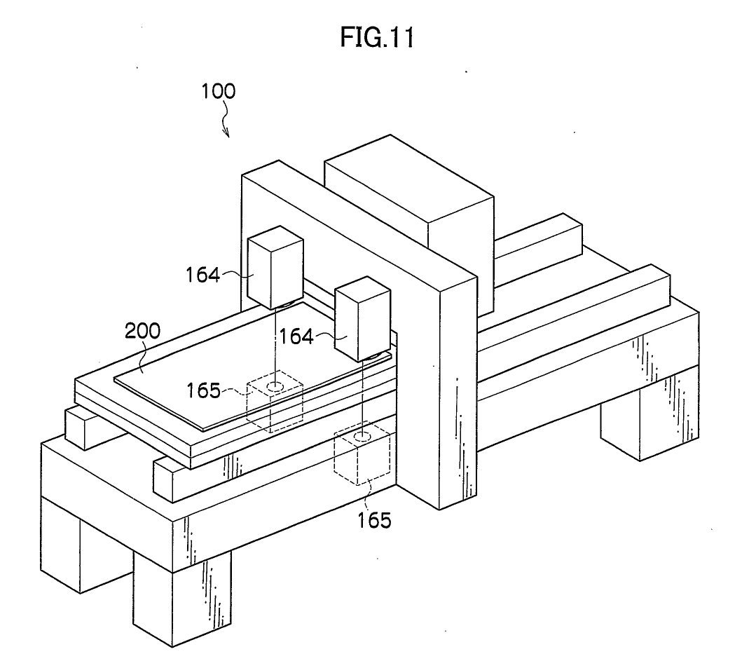

First, in step 201, mark position measurement for deformation correction of the work 12 is carried out. Alignment marks provided on the outer layer of the work 12 are read by CCD cameras, or a pattern (or marks) formed on an inner layer of the work 12 is read by X-ray CCD cameras (see FIG. 11), and data for detecting the deformation of the work 12 is thereby acquired. Note that, as shown in FIG. 4A, the positions of the marks may differ at the inner layer and the outer layer. Further, deformation of the pattern of the inner layer may be detected by using the marks of the outer layer whose relative positions with respect to the marks of the inner layer are known.

In next step 202, data processing for deformation correction of the work 12 is carried out. This is processing in which the original exposure image is deformed by image deformation processing, and the exposure image is deformed according to the deformation of the work 12 which was detected in step 201. Further, if the deformation amount of the work 12 is predictable, the data processing may be carried out on the basis of the predicted deformation amount.

Alternately, data processing for carrying out mapping correction processing may be carried out on the data of the exposure image. Mapping correction processing is a processing of substantially deforming the exposure image by directly changing the positions of the light beams which are to allot image data at the time of exposure. Further, the data processing may be carried out by, firstly creating data which is to be given to the DMD, such as flame data or intermediate data for obtaining the flame data, from the image data in consideration of the deformation correction of the work 12, and performing, with respect to the created data, a processing for correcting position error of the work 12, at the following stage (in step 204). Alternately, position correction based on predicted position errors (predicted values) may be carried out when creating flame data or intermediate data, and plural candidates of position corrected image data may be prepared. Then, at the position correction step of the following stage, optimum position corrected image data may selected. In this case, plural candidates of position corrected image data for correcting rotating errors may be prepared. At the position correction step of the following stage, optimum position corrected image data may selected for correcting the rotating errors, and regular data processing (correction processing) or stage movement may be carried for correcting the other errors. For further alternative, plural candidates of position corrected image data for correcting position errors, in consideration of the rotation errors of the work 12, may be prepared when creating the deformed image data before obtaining the flame data. The optimum candidate may be selected therefrom, and position error correction may be performed thereto.

In step 202, i.e., in the data processing for deformation correction of the work 12, pipeline processing may be carried out. What is called a pipeline mechanism here is a processing step which, by independently operating processing mechanisms of respective stages as shown in FIG. 4B, carries out a next processing simultaneously with the cycle of the preceding processing in the manner of a flow of operations. In a system equipped with a pipeline mechanism, a processing method, in which next processing is carried out at the time of carrying out processing of the preceding stage, is possible.

Namely, at the time when the image processing is carried out by the image processing device 4 as shown in FIG. 1, the data processing for deformation correction is divided into processings of N stages which can be operated independently of one another, as shown in FIG. 4B. By pipeline-processing the data processings for deformation correction of the work 12, the data processings can be carried out more efficiently. Further, processing of a plurality of works 12 can progress simultaneously while successively ascertaining the processing states of the N stages. In this way, N works 12 can be processed successively and simultaneously.

In next step 203, the work 12 is placed at the exposure device 10, and mark position measurement for position correction at the exposure device 10 is carried out. Here, by reading alignment marks 13 which are provided at the work 12 and/or edges of the work 12, the position and inclination of the work 12 at the exposure device 10 are detected, and position data for correcting the position of the exposure image 5 is acquired. Steps from step 203 on, which are surrounded by the dashed line, correspond to processings which the exposure device 10 of FIG. 1 carries out.

In next step 204, data processing for position correction, or stage movement control, is carried out. Based on the position data of the work 12 which was acquired in step 203, the image data is corrected in order to correct the position, or the position is mechanically corrected by moving the stage.

In subsequent step 205, exposure processing is carried out on the work 12 by the exposure device 10 on the basis of the image data which was subjected to the deformation correction (and the position correction). Even in cases in which the work 12 is deformed, the exposure image is subject to deformation processing according to this deformation by the correction processings carried out in the above-described respective steps, and the exposure image can be made to match the deformed image of the inner layer.

Simultaneous processings in accordance with division into regions may be carried out at this time. As shown in FIG. 4C, correction of the entire image is not carried out before the exposure processing, and, at the time when the relative position between the work 12 and the exposure device 10 changes and the work 12 is scan-exposed, correction processing is carried out, before the exposure, for an exposure region 42, at which exposure is to be carried out by the exposure device 10, as a correction region 43. Before the scan-exposure proceeds and the exposure region 42 successively moves on the work 12, the correction region 43 also moves on the work 12. By successively exposing the data of correction region 43 which is corrected, at the exposure regions 42, unexposed regions 44 are successively processed into exposed regions 41. By carrying out exposure successively from regions for which correction is completed as described above, the correction processing and exposure processing can be carried out in parallel.

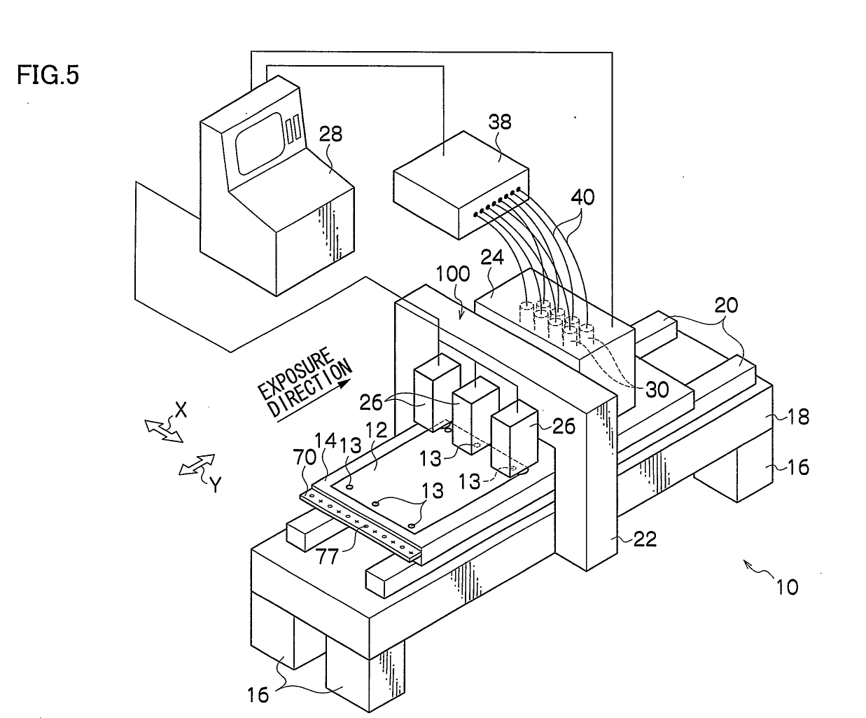

An exposure device, which can be applied to an exposure system, is shown as a second embodiment of the present invention in FIG. 5.

As shown in FIG. 5, the exposure device 10 has a setting stand 18 which is shaped as a thick, rectangular plate and which is supported by four leg portions 16. Two guides 20 are provided so as to extend along the longitudinal direction at the top surface of the setting stand 18. A stage 14 (moving section), which is shaped as a rectangular, flat plate, is provided on these two guides 20. The stage 14 is disposed such that the longitudinal direction thereof is directed in the direction in which the guides 20 extend. The stage 14 is supported so as to be movable above the setting stand 18 by the guides 20, and is driven by an unillustrated driving device, and moves along the guides 20 (in the directions of arrow Y in FIG. 5).

The rectangular plate-shaped work 12 which is the object of exposure, i.e., a work such as a substrate or the like on which a photosensitive material is coated or laminated, is placed on the top surface of the stage 14 in a state of being positioned at a predetermined placement position by a positioning section (not shown). A plurality of groove portions (not shown) are formed in the top surface of the stage 14 (the work placement surface). By making the interiors of these groove portions be negative pressure by a negative pressure supplying source, the work 12 is suctioned to and held at the top surface of the stage 14. Further, the plural alignment marks 13, which show references of the exposure position, are provided on the work 12.

A substantially U-shaped gate 22 is provided so as to straddle over the path of the movement of the stage 14, at the central portion of the setting stand 18. The both end portions of the gate 22 are fixed to the side surfaces of the setting stand 18, respectively. A scanner 24 which exposes the work 12 is provided at one side of the gate 22. An alignment unit 100, which is equipped with a plurality of CCD cameras 26 which photograph the alignment marks 13 provided at the work 12, is provided at the other side of the gate 22.

A detecting section, which detects the illuminated beam positions and the amounts of light thereof and detects the aforementioned positional offset, is disposed at the downstream side in the alignment measuring direction (the upstream side in the exposure direction) of the moving direction of the stage 14 (the directions of arrow Y). The detecting section has a reference plate 70, which is mounted to the alignment measuring direction edge portion of the stage 14, and photosensors (not shown) which are movably attached to the reverse side of the reference plate 70. Reference marks 77 for calibration are provided at the reference plate 70. At times of manufacturing the exposure device 10 or times of carrying out maintenance or the like, calibration operation of the alignment function is carried out by using the reference marks 77 for calibration which are provided at the reference plate 70.

Namely, in order to calibrate the exposure alignment function of the exposure device 10, before the alignment marks 13, which are provided at the work 12 and are references of the exposure position, are read by the CCD cameras 26, the reference plate 70, which has the plurality of reference marks 77 for calibration which are lined-up at predetermined intervals along the moving direction of the CCD cameras 26, is disposed at a position at which reading by the CCD cameras 26 is possible. At least one of the plural reference marks 77 for calibration is read by the CCD cameras 26 which are disposed at positions of reading the alignment marks 13. On the basis of the positional data of the CCD cameras 26 which is acquired by this reading, data for calibration is computed on the basis of positional offset data between the image pickup optical axis (the lens optical axis) and the reference marks 77 for calibration, or the like, and this data for calibration is made to be reflected in the reference position data.

In this way, it is possible to calibrate the exposure alignment function whose accuracy is affected primarily due to changes in posture which accompany movement of the CCD cameras 26, and the accuracy of correcting the exposure position offset with respect to the work 12 can be improved. In the present second embodiment, differently than the first embodiment shown in FIG. 1, by reading the alignment marks 13 of the work 12 on the exposure device 10, data acquisition for deformation correction is carried out, and data acquisition for position correction is also carried out. Therefore, the number of machines, the places for placement of the machines, and the like can be reduced.

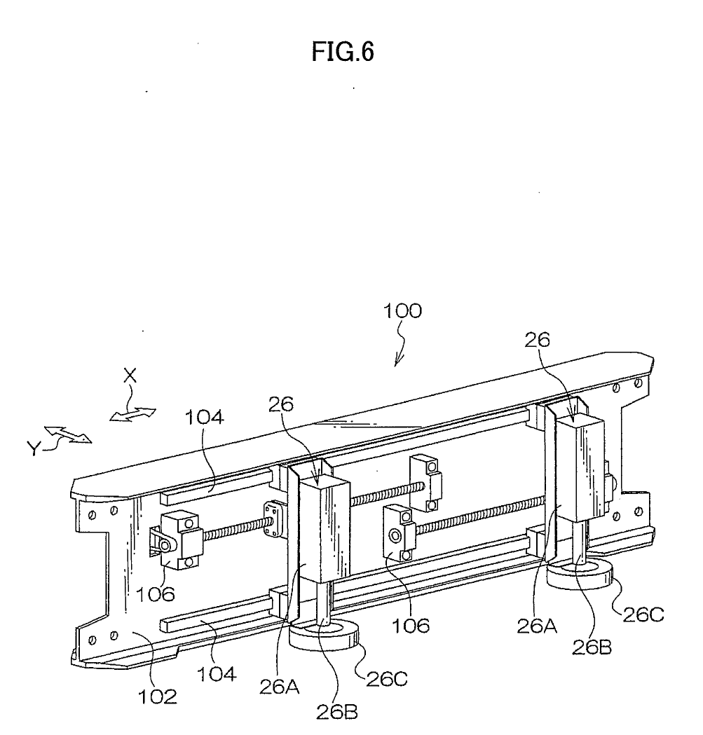

The alignment unit relating to the second embodiment of the present invention is shown in FIG. 6.

As shown in FIG. 6, the alignment unit 100 has a rectangular unit base 102 which is mounted to the gate 22. A pair of guide rails 104 are provided at the side of the unit base 102 at which the cameras are disposed, so as to extend along the direction (the directions of arrow X) which is orthogonal to the moving direction of the stage 14 (the directions of arrow Y). The CCD cameras 26 are slidably guided by the pair of guide rails 104. The respective CCD cameras 26 are driven by ball screw mechanisms 106, which are provided individually therefor, and drive sources (not shown), such as stepping motors or the like which drive the ball screw mechanisms 106. Thereby the CCD cameras 26 move independently in a direction orthogonal to the moving direction of the stage 14. Each of the CCD cameras 26 is disposed at a posture such that a lens portion 26B, which is provided at a distal end of a camera main body 26A, is directed downward and the lens optical axis is substantially vertical. A ring-shaped flash light source (LED flash light source) 26C is mounted to the distal end portion of the lens portion 26B.

When the respective CCD cameras 26 are to photograph the alignment marks 13 of the work 12, they are moved in the directions of arrow X by the aforementioned drive sources and ball screw mechanisms 106, and are respectively disposed at predetermined photographing positions. Namely, the lens optical axes are disposed so as to coincide with positions of passage of the alignment marks 13 of the work 12 which moves as the stage 14 moves. At the time when the alignment marks 13 reach the predetermined photographing positions, the flash light sources 26C are made to emit light. The reflected light, which is reflected at the top surface of the work 12, of the flash light illuminated onto the work 12, is inputted to the camera main bodies 26A via the lens portions 26B, and the alignment marks 13 are thereby photographed.

The driving device of the stage 14 and the driving sources for moving the scanner 24, the CCD camera 26, and the CCD camera 26, are connected to a controller 28 (see FIG. 5) which controls them. When the exposure operation of the exposure device 10 which will be described later, the stage 14 is controlled by the controller 28 so as to move at a predetermined speed, the CCD cameras 26 are controlled by the controller 28 so as to be disposed at the predetermined positions and so as to photograph the alignment marks 13 of the work 12 at predetermined times, and the scanner 24 is controlled by the controller 28 so as to expose the work 12 at a predetermined time.

When the exposure operation of the exposure device 10 begins, the driving device is controlled by the controller 28, and the stage 14, which is suctioning the work 12 at the top surface thereof, starts to move along the guides 20 at a constant speed from the upstream side to the downstream side in the alignment measuring direction of the moving direction (the directions of arrow Y). Synchronously with this start of movement of the stage, or at a time which is slightly before the leading end of the work 12 reaches the region directly beneath the CCD cameras 26, the CCD cameras 26 are controlled by the controller 28 to operate.

When the work 12 passes under the CCD cameras 26 as the stage 14 moves, alignment measurement by the CCD cameras 26 is carried out.

In this alignment measurement, first, when the alignment marks 13 provided at the moving direction downstream side (the front end side) of the work 12 reach the region directly beneath the CCD cameras 26 (reach a region on the optical axes of the lenses), the CCD cameras 26 photograph the alignment marks 13 at predetermined times. The photographed image data, i.e., image data including reference position data in which references of the exposure position are shown by the alignment marks 13, is outputted to a CPU which is a data processing section of the controller 28. After the alignment marks 13 are photographed, the stage 14 again starts to move toward the downstream side.

In a case in which plural alignment marks 13 are provided along the moving direction (scanning direction) as is the case of the work 12 of the present embodiment, when the next alignment marks 13 (the alignment marks 13 provided at the moving direction upstream side (rear end side)) reach the region directly beneath the CCD cameras 26, the CCD cameras 26 similarly photograph the alignment marks 13 at predetermined times, and output the image data thereof to the CPU of the controller 28.

At this time, conventionally, the correction with respect to the deformation of the work 12 and the correction with respect to the position and posture of the work 12 are both carried out simultaneously from the position data obtained by the photographing of the alignment marks 13. Therefore, the amount of computation is large and is a cause of a reduction in the processing speed.

In consideration of this point, in the present invention, the correction with respect to the deformation of the work 12 is carried out separately from and in advance of the correction with respect to the position and the posture of the work 12, in the exposure alignment function. In this way, the exposure device 10 which can improve the processing ability and a calibration method thereof are provided.

### Order of Correction

First, from the mark positions and the pitches between marks or the like within the image which are identified from the inputted image data of the alignment marks 13 (the reference position data), the CPU grasps the dimensional accuracy errors, the warping, and the like of the work 12, and computes the correct exposure position for the surface to be exposed of the work 12. Then, at the time of image exposure by the scanner 24, correction control (alignment) is executed which combines a control signal, which is generated on the basis of image data of an exposure pattern stored in an unillustrated memory, with this correct exposure position, and carries out image exposure.

Namely, the errors in the configurational and dimensional accuracy of the work 12 are peculiar to each respective work 12. Therefore, the positions of the alignment marks 13 at three or more places are detected in advance by the CCD cameras 26 or another detecting section, and data for correcting in advance the errors in dimensional accuracy, the warping, and the like of the work 12 can be acquired.

In this way, the correction processing needed for exposure can be divided, and the amount of correction processing which must be carried out immediately before exposure at the exposure device 10 can be reduced. Therefore, the processing ability of the exposure device 10 can be improved.

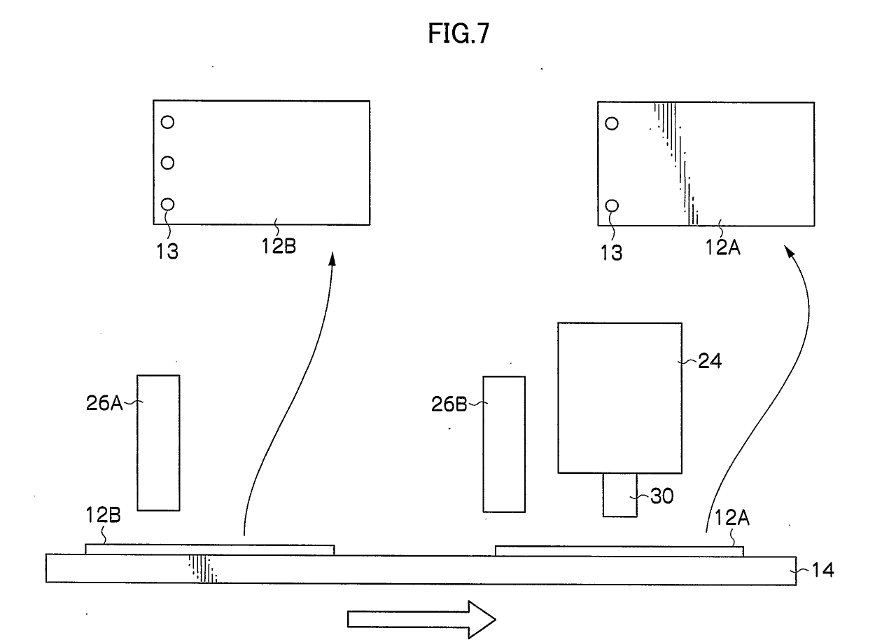

A modified example of the exposure system relating to the present invention is shown in FIG. 7.

In order to divide the computation amount of the correction data needed for exposure as described above, as shown in FIG. 3 for example, a single or plural works 12 may be placed on the stage 14, and the dimensional accuracy errors and warping of the work 12, the offset of the placed position of the work 12 on the stage 14, and the inclination of the work 12 with respect to the moving direction may be individually and independently detected by the plural CCD cameras 26A, 26B. In this case, a structure in which the sheet-shaped or elongated work 12 is moved (conveyed) successively with respect to the stage 14, or a structure in which a plurality of stages 14 are moved cyclically, can be employed.

Specifically, first, three or more alignment marks 13 on a work 12A which is to be exposed precedingly are detected by the CCD camera 26A exclusively used for warping correction, and data for warping correction is acquired. Thereafter, the stage 14 is driven in the direction of the arrow by the driving device, and moves in the exposure direction along the guides 20.

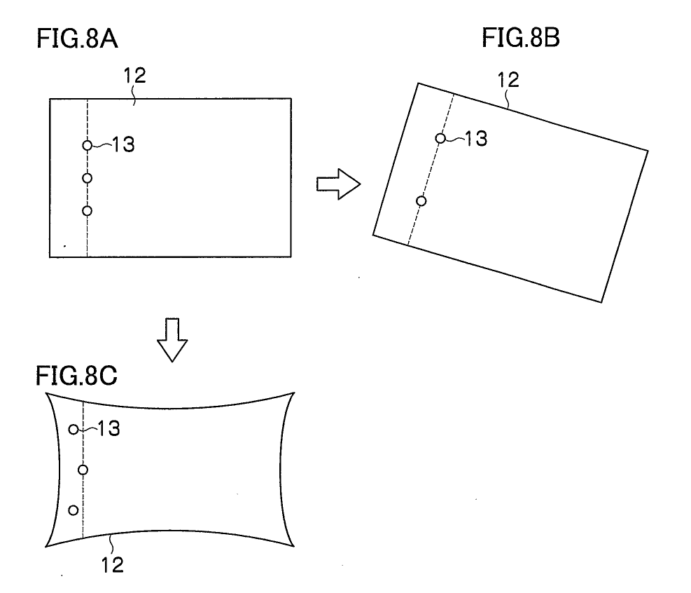

As shown in FIGS. 8A through 8C, the inclination and position of the work 12 can be computed if at least two alignment marks 13 are detected. However, with respect to warping and deformation of the work 12, detection of at least three alignment marks 13 is needed.

Specifically, as shown in FIG. 8B for example, the position and inclination of the work 12 can be detected by detection of two or fewer alignment marks 13. However, as shown in FIG. 8C, in a case in which both the positional offset and the inclination are zero but warping exists, in order to detect this warping, at least three or more alignment marks 13 must be detected.

From the mark positions and the pitches between marks within the image which are identified from the inputted image data of the two or more alignment marks 13 (the reference position data) and the position of the stage 14 and the position of the CCD camera 26B at the time when these alignment marks 13 are photographed, by computation processing, the CPU grasps the offset of the placement position of the work 12 on the stage 14 and the inclination of the work 12 with respect to the moving direction, and computes a correct exposure position for the surface to be exposed of the work 12. Then, at the time of image exposure by the scanner 24, correction control (alignment) is executed which combines a control signal, which is generated on the basis of image data of an exposure pattern stored in an unillustrated memory, with this correct exposure position, and carries out image exposure.

Namely, the position and the inclination of the work 12 with respect to the exposure device 10 (or with respect to the stage 14) are detected, and these are corrected. It is effective to carry out this correction immediately before exposure, because the position and inclination cannot be detected and computed if the work 12 is not in a state of being placed at the exposure position on the stage 14.

At this time, in a case in which both the positional offset and the inclination of the work 12 are zero but warping exists as described above, in order to detect this warping, three or more alignment marks 13 must be detected. However, because the position and inclination of the work 12 can be detected by detection of two or less alignment marks 13 as shown in FIG. 8B, it suffices for the alignment marks 13 to be detected at two places. In this way, it also suffices for there to be two CCD cameras 26B, and costs can also be decreased.

When, as the stage 14 moves, the work 12 moves beneath the scanner 24 toward the downstream side in the exposure direction and the image exposure region of the surface to be exposed reaches the exposure start position, respective exposure heads 30 of the scanner 24 illuminate light beams, and image exposure of the surface to be exposed of the work 12 starts. Note that, while the position correction and exposure processing of the preceding work 12 are being carried out, the deformation correction of the next work 12 may be carried out.

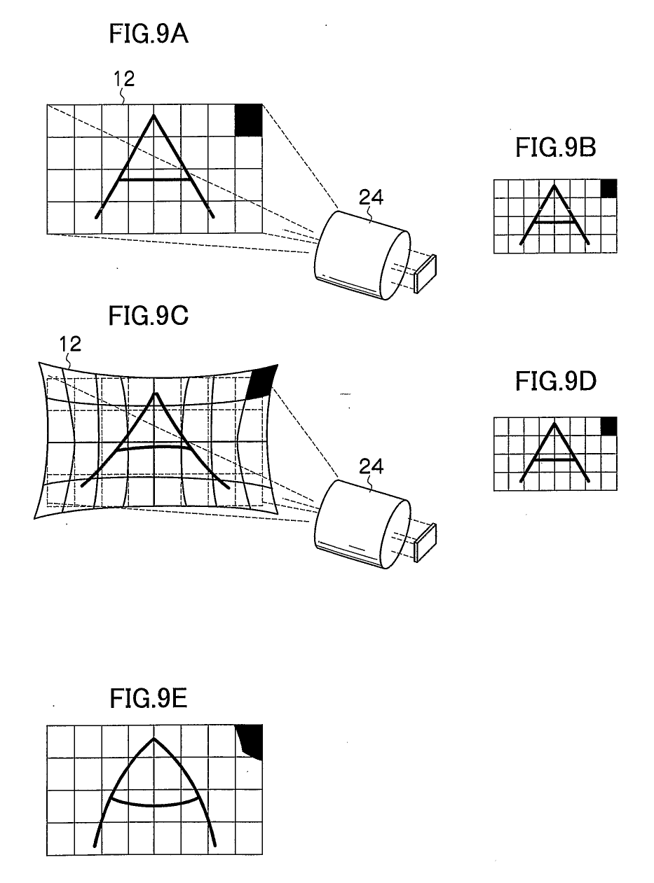

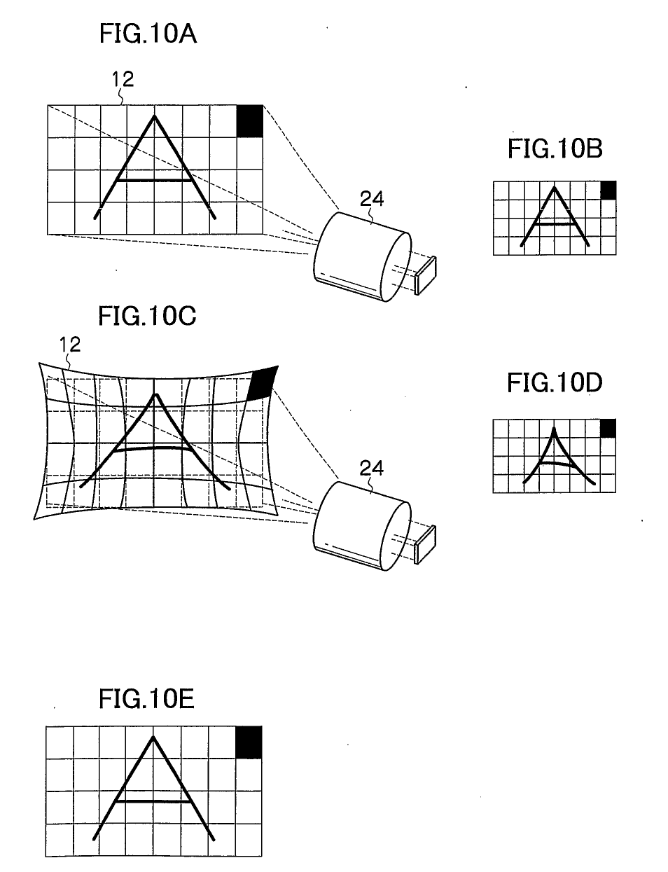

Modified examples of the warping correction method of the exposure device relating to the present invention are shown in FIGS. 9A through 9E and FIGS. 10A through 10E.

In a case in which the work 12 does not have any warping such as expansion or contraction or deformation or the like as shown in FIG. 9A, the exposure image inputted to the scanner 24 also is an image which does not have warping as shown in FIG. 9B, and there is no problem.

However, in a case in which the work 12 is deformed as shown in FIG. 9C, if an image such as shown in FIG. 9D is inputted to the scanner 24 as is, an image such as shown in FIG. 9A is exposed as is. As a result, if the convexity or concavity and the expansion or contraction are corrected after the developing processing or if this work 12 is used as a multilayer substrate as will be described later, the image deforms in a configuration which is opposite that of the original deformation of the substrate, as shown in FIG. 9E.

Thus, with respect to deformation of the work 12 such as shown in FIG. 10C, the exposure image inputted to the scanner 24 is deformed according to the deformation of the work 12 as shown in FIG. 10D, and exposure is carried out.

In this way, after the developing processing, the convexity or concavity and the expansion or contraction return to the original state, or, when the work 12 is used as a multilayer substrate as will be described later, the original correct image is subjected to developing processing, and an image such as shown in FIG. 10E can be obtained.

In the above-described structure, the step of carrying out the deformation correction processing (the processing of computing the corrected pattern, such as the deformation correction processing of the image data or the like) from the warping information of the work 12 which is obtained by the CCD camera 26A, imposes the greatest burden. Therefore, plural lines of the steps of detecting the plurality of alignment marks 13 by the CCD camera 26A up to computing the warping correction data for each one work 12 (the steps which can be processed before placement on the stage 14) are readied. The steps up to the computation of the warping correction data, which requires the most time, are carried out in parallel, and the work 12, for which processing is completed, is exposed at the stage 14. In accordance with such a structure, the processing ability as an overall system can be improved even more.

### Hole Punching of Multilayer Substrate

Usually, there are cases in which a single substrate is used, but also there are cases in which plural substrates are superposed so as to form a multilayer substrate and create one part.

Here, at the time of superposing the substrates, on a substrate on which a pattern has already been formed, a substrate is further superposed, and processings such as patterning or the like are carried out. Therefore, it is difficult for an optical-type reading device to detect the pattern position of the layer beneath (the inner layer). Thus, the pattern position of the inner layer can be read by using a see-through reading device using X-rays which pass through the substrate, and can be used in the alignment for the exposure of a pattern to be drawn on the substrate of the upper layer which is formed thereon.

Namely, acquisition of data for warping correction can also be carried out by reading the plural pattern positions of the multilayer substrate, on which exposure processing is to be carried out on the stage 14 of the exposure device from here on, by a see-through reading section which reads the pattern position of the inner layer by X-rays instead of by the above-described CCD camera 26A. Hereinafter, explanation of a variant example of the measuring device 3 will be given as a third embodiment of the present invention.

Specifically, in a hole-punching device 100 such as shown in FIG. 11 which is equipped with X-ray CCD cameras 164 and X-ray light sources 165 for example, an example will be described of a case in which blind via holes (BVH) are formed in vicinities of the four corners of a rectangular substrate respectively, and alignment adjustment of a build-up printed wiring board 200, at which these respective BVHs become alignment marks at the time of manufacturing the substrate, is carried out at the exposure device 10. Or, as another variant example, other than a hole punching device, a marking device may be used.

The build-up wiring board 200 which is placed on the stage is conveyed. When the plural BVHs formed in a vicinity of the end portion at the leading end side in the moving direction approach the region beneath the X-ray CCD cameras 164A, 164B, the see-through images of the BVHs are picked-up by the X-ray CCD cameras 164. In this way, the contours of the BVHs are picked-up sharply, and can be identified as alignment marks. Or, instead of the BVHs, position information of a pattern already formed at the inner layer may be detected.

From the BVHs used as the alignment marks or the position information of the pattern already formed at the inner layer, warping (deformation and expansion or contraction) information is acquired and correction is carried out by the above-described method, before the position and inclination correction of the build-up wiring board 200. In this way, the processing time needed for detecting the positions of the alignment marks and computing the correction values can be reduced. In the same way as in the other embodiments, the processing ability of the exposure device can be improved.

In the present embodiment, the position information of the alignment marks is acquired by using the X-ray CCD cameras of the hole punching device. Therefore, there is the advantage that it is possible to acquire position information from the inner layer structure of the substrate, which cannot be detected by a usual optical detecting section such as a CCD camera or the like. In this way, problems in acquiring the position information do not arise even in cases in which it is difficult to provide the alignment marks on the surface of the substrate or it is difficult to read them. In the present embodiment, the X-ray CCD cameras 164 are provided at the hole punching device 100. However, the present invention is, of course, not limited to this configuration, and the X-ray CCD cameras 164 may be provided at another device or may be used as a unit.

### Double-Sided Exposure

Not only one side, but both sides of the work 12 can be used as exposure surfaces. By carrying out image formation on one side by patterning processing and the like, and thereafter, carrying out similar processings on the other side as well, the needed number of works 12 can be reduced. Namely, a form is conceived of in which exposure is carried out at the exposure device on both the reverse and obverse of the same substrate by using through-holes as positional references.

At this time, the warping (deformation and expansion or contraction) information acquired at one side is substantially effective for the other side as well, and can be reversed and used if the non-uniformity of the thickness of the work 12 is within a predetermined allowable range. Hereinafter, an exposure device relating to a fourth embodiment of the present invention will be described.

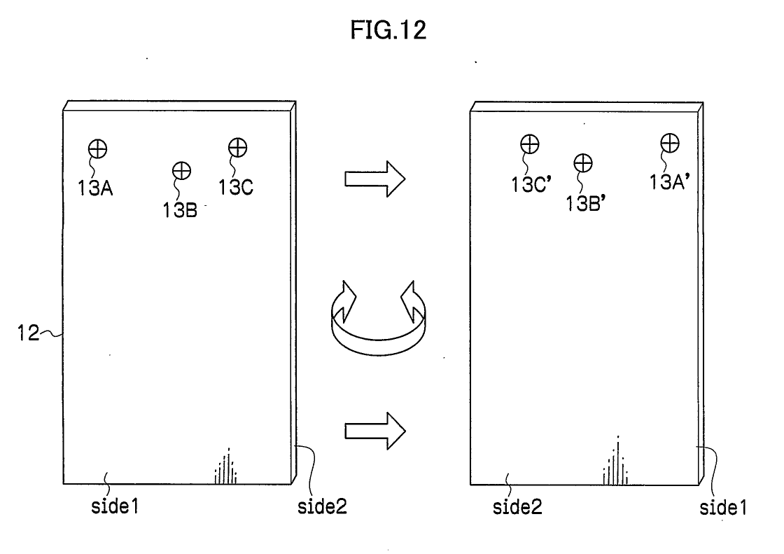

Concretely, as shown in FIG. 12 for example, from the position information of the alignment marks 13A through 13C of Side 1 which is the surface of the work 12 at which exposure is carried out first, warping (deformation and expansion or contraction) information is acquired before the position and inclination information of the work 12. Thereafter, the position and inclination information on the stage 14 are acquired, correction is carried out, and exposure is carried out.

Next, before the work 12 is turned-over and exposure is carried out, the warping (deformation and expansion or contraction) information of Side 2 is computed as information which reverses the warping information computed from the position information of the alignment marks 13A through 13C of Side 1.

Namely, the alignment marks 13A through 13C will be 13A′ through 13C′ at Side 2. Therefore, at Side 2, positional measurement of the alignment marks 13 is not carried out, information which reverses the warping information of Side 1 is computed, only the position and inclination information on the stage 14 are acquired, correction is carried out, and exposure is carried out. In this way, the processing time needed for the position detection of the alignment marks 13 and the computation of the correction values is reduced, and the processing ability of the exposure device 10 can be improved.

Because the present invention has the above-described structure, warping correction processing, whose burden on the exposure device is large, is carried out separately from the exposure position correction processing. The manufacturing ability of the exposure device can thereby be improved.

Further, the mechanism, which carries out data acquisition needed for the warping correcting processing, can be separated from the exposure device main body. Therefore, warping measurement can be carried out before coating or laminating of the resist which is a photosensitive layer. Because warping measurement can be carried out at the stage before the work has photosensitivity, there are no constraints relating to the wavelengths of the X-rays or the light which are used in measurement. Namely, arbitrary lights having any wavelength or X-rays can be used in measurement.

Further, in the above-described embodiments, the exposure device, which carries out exposure on a work and forms an image, is used as an example. However, the present invention is not limited to the same, and can of course be applied as well to, for example, image forming devices having recording heads using jetting nozzles, or the like.

1. A correction method of an image-drawing device which carries out alignment on an object on the basis of reference position data acquired by reading a position reference mark or pattern provided at the object, and which carries out image-drawing on the object in accordance with image data while moving the object in a scanning direction, the method comprising:
carrying out first correction which corrects an image-drawing position with respect to deformation of the object; and
carrying out second correction which corrects an image-drawing position with respect to a position of the object,
wherein the first correction is carried out before the second correction.

2. The correction method of an image-drawing device of claim 1, wherein the first correction is carried out by using a number of position reference marks or patterns, which number is greater than or equal to that used in the second correction.

3. The correction method of an image-drawing device of claim 1, wherein, before the image-drawing ends, the first correction with respect to deformation of an object which is to be image-drawn next is completed.

4. The correction method of an image-drawing device of claim 1, wherein a plurality of the position reference marks or patterns are read by an auxiliary reading section which is provided in advance at an exterior of the image-drawing device, and the first correction is carried out on the basis of acquired reference position data, and
thereafter, the second correction is carried out on the basis of reference position data acquired by reading by a reading section which is provided at the image-drawing device.

5. The correction method of an image-drawing device of claim 4, wherein a see-through reading section using X-rays is used as the auxiliary reading section.

6. The correction method of an image-drawing device of claim 1, wherein, when the image-drawing device is carrying out image-drawing of both sides by using a through-hole as a position reference, during image-drawing of one side,
the first correction with respect to deformation of another side is carried out on the basis of position data which rotates or reverses reference position data acquired from the position reference mark or pattern for the side currently in the midst of image-drawing.

7. The correction method of an image-drawing device of claim 1, wherein a see-through reading section using X-rays is provided at a device which carries out marking or hole-punching processing on a substrate structuring the object, and
the first correction is carried out on the basis of reference position data acquired by reading position information of an inner layer structure of the substrate by the see-through reading section.

8. The correction method of an image-drawing device of claim 1, wherein the image-drawing is exposure processing by light beams.

9. An image-drawing device comprising:
a reading section reading a position reference mark or pattern provided at an object;
an aligning section carrying out alignment for the object on the basis of reference position data acquired by reading by the reading section;
a moving section moving the object in a scanning direction; and
an image-drawing section carrying out image-drawing on the object in accordance with image data, while moving the object in the scanning direction by the moving section,
wherein the aligning section carries out first correction which corrects an image-drawing position with respect to deformation of the object, before second correction which corrects an image-drawing position with respect to a position of the object.

10. The image-drawing device of claim 9, wherein the first correction is carried out by using a number of position reference marks or patterns, which number is greater than or equal to that used in the second correction.

11. The image-drawing device of claim 9, wherein, before the image-drawing ends, the first correction with respect to deformation of an object which is to be image-drawn next is completed.

12. The image-drawing device of claim 9, wherein a plurality of the position reference marks or patterns are read by an auxiliary reading section which is provided in advance at an exterior of the image-drawing device, and the first correction is carried out on the basis of acquired reference position data, and
thereafter, the second correction is carried out on the basis of reference position data acquired by reading by the reading section which is provided at the image-drawing device.

13. The image-drawing device of claim 12, wherein a see-through reading section using X-rays is used as the auxiliary reading section.

14. The image-drawing device of claim 9, wherein, when the image-drawing device is carrying out image-drawing of both sides by using a through-hole as a position reference, during image-drawing of one side,
the first correction with respect to deformation of another side is carried out on the basis of position data which rotates or reverses reference position data acquired from the position reference mark or pattern for the side currently in the midst of image-drawing.

15. The image-drawing device of claim 9, wherein a see-through reading section using X-rays is provided at a device which carries out marking or hole-punching processing on a substrate structuring the object, and
the first correction with respect to deformation of the object is carried out on the basis of reference position data acquired by reading position information of an inner layer structure of the substrate by the see-through reading section.

16. The image-drawing device of claim 9, wherein the image-drawing is exposure processing by light beams.

17. An image-drawing method for forming an image on an object by using an image-drawing section, the method comprising:
measuring deformation of the object;
carrying out deformation correction processing for forming a deformed image on the object in accordance with the deformation;
measuring a positional error of the object with respect to the image-drawing section;
carrying out position correction processing for forming an image, whose position is corrected, on the object in accordance with the positional error; and
image-drawing an image on the object,
wherein the deformation correction processing is completed before the measuring of the positional error or the position correction processing.

18. The image-drawing method of claim 17, wherein, at a stage when the position correction processing with respect to a first partial region of the object is completed, image-drawing of the image with respect to the first partial region is started.

19. The image-drawing method of claim 18, wherein, simultaneously with the image-drawing of the image with respect to the first partial region, the position correction processing with respect to a second partial region of the object is carried out.

20. The image-drawing method of claim 17, wherein, simultaneously with at least one of a). the measuring of the positional error with respect to the object, b). the position correction processing, and c). the image-drawing of the image, the deformation correction processing with respect to another object is carried out.

21. The image-drawing method of claim 17, wherein the measuring of the deformation is carried out by reading, in a see-through manner and by using X-rays, a position of a mark or a pattern provided at the object.

22. The image-drawing method of claim 17, wherein at least one of the measuring of the deformation and the measuring of the positional error is carried out by reading a position of a mark or a pattern provided at the object.

23. An image-drawing method for forming an image on an object by using an image-drawing section, the method comprising:
a first correction step of measuring positions of at least two reference marks or patterns on the object, and carrying out correction processing for forming, on the object, an image corresponding to a relative positional relationship between the positions of the reference marks or patterns;
a second correction step of measuring the positions of the at least two reference marks or patterns on the object, or positions of at least two other reference marks or patterns, and carrying out correction processing for forming, on the object, an image corresponding to a positional relationship between the image-drawing section and the positions of the reference marks or patterns; and
a step of image-drawing an image on the object,
wherein the first correction step is completed before the second correction step.

24. An image-drawing system for forming an image on an object by using an image-drawing section, the system comprising:
a measuring section measuring deformation of the object;
a deformation correction processing section for forming a deformed image on the object in accordance with the deformation;
a positional error measuring section measuring a positional error of the object with respect to the image-drawing section;
a position correction processing section for forming an image, whose position is corrected, on the object in accordance with the positional error; and
an image-drawing section carrying out image-drawing of an image on the object,
wherein the deformation correction processing is completed before the measuring of the positional error or the position correction processing.
